(19) United States
(12) Patent Application Publication
(10) Pub. No.: US 2013/0078431 A1
(43) Pub. Date: Mar. 28, 2013

(54) COMPOSITION FOR LABEL BASE, METHOD FOR PRODUCING LABEL BASE, AND LABEL

(71) Applicants: Tomohumi SANO, Saitama (JP); Toshiaki KANAMURA, Tokyo (JP)

(72) Inventors: Tomohumi SANO, Saitama (JP); Toshiaki KANAMURA, Tokyo (JP)

(73) Assignees: CASIO COMPUTER CO., LTD., Tokyo (JP); CASIO ELECTRONICS MANUFACTURING CO., LTD., Saitama (JP)

(21) Appl. No.: 13/612,087

(22) Filed: Sep. 12, 2012

(30) Foreign Application Priority Data
Sep. 28, 2011 (JP) 2011-212359
May 31, 2012 (JP) 2012-123874

(51) Int. Cl. B32B 3/10; C08G 63/183; G03G 15/08; C08G 63/16

(52) U.S. Cl. 428/195.1; 528/272; 528/302; 399/252

(57) ABSTRACT

The present invention relates to: a composition for label base containing a polyester resin having a repeating unit formed by condensation of an aliphatic dicarboxylic acid and an aliphatic diol; a method for producing a label base containing developing the composition for label base to form a solid image having a label shape, transferring the solid image onto a pressure-sensitive adhesive layer side of a release paper, and fixing the transferred solid image on the pressure-sensitive adhesive layer by heat and pressure application into a film shape; and a label containing the label base and a label image provided thereon obtained by transferring a toner image to the label base and fixing the transferred toner image to the label base by heat and pressure application

### CROSS-REFERENCE TO RELATED APPLICATION

The present application claims priority to Japanese patent application No. 2011-212359 filed on Sep. 28, 2011 and Japanese patent application No. 2012-123874 filed on May 1, 2012, each of which is incorporated herein by reference in their entirety.

### FIELD OF THE INVENTION

The present invention relates to a composition for label base (hereinafter referred to as a label base composition) excellent in film characteristics such as tensile strength and impact strength, in film forming properties such as a softening point, powder characteristics, and fixability, and in printability, to a label base prepared from the label base composition, and to a method for producing a label from the label base composition.

### BACKGROUND ART

A method for making an adhesive-backed label is known. In this method, usually, an adhesive-backed label is produced by providing a label stock comprising a support and an adhesive applied to the back side of the support, in which a release sheet is releasably attached to the adhesive-backed side of the label stock, printing information (drawing patterns, designs, letters etc.) on the main side of the label stock, and cutting the printed label stock to an arbitrarily shape with a cutting die.

The cutting is effected to cut only the label stock, that is, cut the support and the adhesive layer (half cut) or cut the release sheet as well as the support and the adhesive layer (full cut). Whichever cutting manner is adopted, this method necessarily involves preparation of a printing plate for printing information and a cutting die for cutting the printed label stock in accordance with the size or shape of the printed information for producing one type of label.

This method is not problematic when one type of label is to be produced in large quantity. In the case of small-quantity production, however, the problem to solve with the method is that an increased unit price of the resulting labels due to high manufacturing costs of the printing plate and the cutting die.

To solve the problem, the assignee of the present application proposes a method for preparing a label with any desired shape on demand, in which a desired toner image is developed by an electrophotographic technique, followed by heat treatment, to thereby form a label, as described in Patent Document 1. In order for labels produced by such a method to have improved label characteristics, it is important to improve the characteristics of a label base composition forming a label base in film form.

In Patent Document 1 supra, a polyvinyl acetal resin is used as a main component of a toner for the label base. Besides, Patent Document 2 discloses use of polylactic acid as a label constituting resin, and Patent Document 3 discloses use of a UV curable polyester as a label constituting resin. In addition. Patent Document 4 discloses use of polyethylene terephthalate (PET) as a label base and a polyester including polybutylene succinate as an image receiving layer of the label base.

Although it is not as a label base, Patent Document 5 discloses use of polybutylene succinate as a resin component of a toner, thereby to form a toner image with good color reproducibility.

Although the polyvinyl acetal resin used in Patent Document 1 exhibits relatively good characteristics as a general toner, when it is developed, transferred, and fixed to make a film serving as a label base, the resulting film is brittle and insufficient for use as a label base.

While the use of polylactic acid as proposed in Patent Document 2 brings about improvement of film characteristics, the improvement is less than sufficient. Also, this technique has a problem to solve that polylactic acid has a high melting or softening temperature and therefore needs a large amount of heat to be converted to label film.

The method disclosed in Patent Document 3 comprising causing a molten resin to polymerize by the action of UV light is effective in increasing label film strength. The problem to solve with this method, however, lies in that a UV light source is required separately and that a sufficient increase in film strength is not achieved without increasing the UV output.

According to Patent Document 4, a toner image receiving layer of polybutylene succinate is provided so as to improve printability of the label base made of PET. However, this Patent Document is silent on the strength of the label film made of PET.

The technique disclosed in Patent Document 5 employs polybutylene succinate not in a toner image receiving layer but in a toner itself which is to form an image. However, this Patent Document has neither of disclosure nor suggestion of the idea of making a label film by using a toner.

While a styrene-acrylic resin is widely used as a resin for toners, a film formed of a styrene-acrylic resin has poor film characteristics, such as considerably poor bending properties. The inventors of the present invention measured tensile strength of such a styrene-acrylic resin film and ascertained that the poor film characteristics is attributed to an extremely small elongation as represented by tensile elongation at break of less than 1%.

### CITATION LIST

### Patent Document

Patent Document 1: Japanese Patent No. 4,765,810

Patent Document 2: JP 2011-008047A

Patent Document 3: JP 2010-184470A

Patent Document 4: JP 2005-173182A

Patent Document 5: JP 2011-095342A

### SUMMARY OF THE INVENTION

The present invention has been accomplished under the above circumstances and has objects to provide a label base composition excellent in film characteristics such as tensile strength and impact strength, in film forming properties such as a softening point, powder characteristics, and fixability, and in printability; a label base prepared from the label base composition, and a method for producing a label from the label base composition.

In order to attain the above objects, the composition for label base according to the present invention contains, as a main component of binder resin, a polyester resin including a repeating unit (single monomer unit represented by the following formula (1)) formed by condensation of an aliphatic dicarboxylic acid (first dicarboxylic acid) and an aliphatic diol. Here, the term “main component” in the above phrase “as a main component of binder resin” means that the component occupies more than one-half of the whole amount of the binder resin.

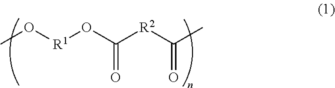

The aliphatic dicarboxylic acid is preferably succinic acid.

The polyester resin may further have another repeating unit formed by condensation of another dicarboxylic acid (second dicarboxylic acid) than succinic acid and an aliphatic diol in addition to the repeating unit formed by condensation of an aliphatic dicarboxylic acid and an aliphatic diol, as shown in the following formula (2).

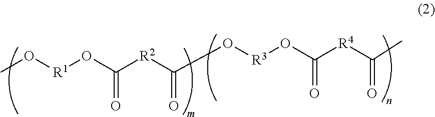

In the above formulae (1) and (2), R¹ and R³ may be the same or different and each represents divalent group having carbon number of 2 to 6, R² and R⁴ may be the same or different and each represents divalent group having carbon number of 2 to 8, and these divalent groups may have a hetero atom.

The molar ratio of the other dicarboxylic acid (second dicarboxylic acid) than succinic acid to the total amount of dicarboxylic acids copolymerized with the aliphatic diol is preferably 50% or less.

The aliphatic diol is preferably 1,4-butanediol.

When a film sample is formed of the composition for label base according to the present invention, the film preferably has a breaking elongation of 50% to 450% in a tensile test.

The composition for label base according to the present invention preferably has a softening point of 140° C. or lower.

In order to attain the above objects, the method for producing a label base according to the present invention contains: developing a composition for label base containing, as a main component, a polyester resin having a repeating unit formed by condensation of an aliphatic dicarboxylic acid and an aliphatic diol to form a solid image having a label shape; transferring the solid image onto a pressure-sensitive adhesive layer side of a release paper; and fixing the transferred solid image on the pressure-sensitive adhesive layer of the release paper by heat and pressure application into a film shape, to thereby form a label base containing the release paper and the solid image of the composition for label base fixed on the pressure-sensitive adhesive layer of the release paper into a film shape.

The aliphatic dicarboxylic acid is preferably succinic acid, and the aliphatic diol is preferably 1,4-butanediol.

In order to attain the above objects, the label according to the present invention contains a label base and a label image provided thereon, in which the label base is formed by developing a composition for label base containing, as a main component, a polyester resin having a repeating unit formed by condensation of an aliphatic dicarboxylic acid and an aliphatic diol to form a solid image having a label shape, transferring the solid image onto a pressure-sensitive adhesive layer side of a release paper, and fixing the transferred solid image on the pressure-sensitive adhesive layer of the release paper by heat and pressure application into a film shape, to thereby form the label base comprising the release paper and the solid image of the composition for label base fixed on the pressure-sensitive adhesive layer of the release paper into a film shape, and in which the label image is formed by transferring a toner image to the label base, and fixing the transferred toner image to the label base by heat and pressure application.

The aliphatic dicarboxylic acid is preferably succinic acid, and the aliphatic diol is preferably 1,4-butanediol.

According to the present invention, there can be provided a label base composition excellent in film characteristics such as tensile strength and impact strength, in film forming properties such as a softening point, powder characteristics, and fixability, and in printability, a label base prepared from the label base composition, and a method for producing a label from the label base composition.

### BRIEF DESCRIPTION OF THE DRAWINGS

A more complete under standing of the present application can he obtained when the following detailed description is considered in conjunction with the following drawing, in which:

FIG. 1 is a cross-sectional view showing the structure of an image forming apparatus which is an apparatus for forming a label base and a label of Example 1, in which the label base is formed on a pressure-sensitive adhesive layer side of a release paper using a label base composition and a label is formed by forming an ordinary toner image on the label base.

### DETAILED DESCRIPTION OF THE INVENTION

The invention will be described in detail based on its preferred embodiments with reference to the drawing.

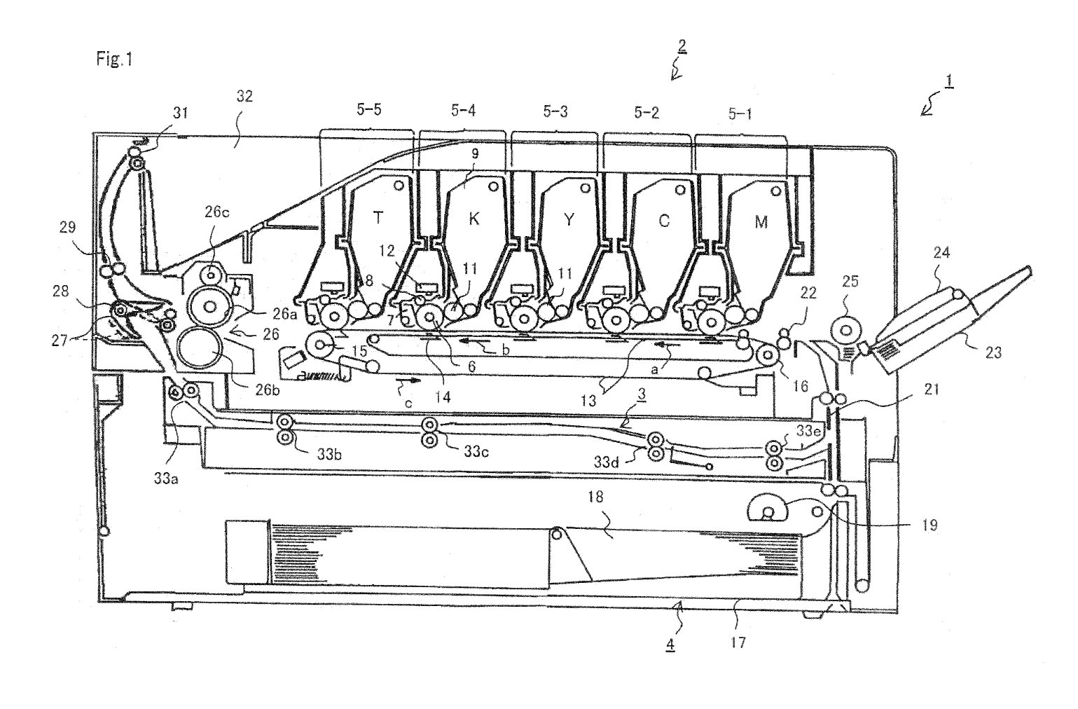

FIG. 1 is a cross-sectional view showing the structure of the image forming apparatus for forming a label base and a label of Example 1. The image forming apparatus 1 of FIG. 1 operates to form a label base on a pressure-sensitive adhesive layer side of a release paper using a hereinafter described label base composition (hereinafter also called a label base toner for the sake of convenience) and to make a label by forming an ordinary toner image on the label base.

As illustrated in FIG. 1, the image forming apparatus 1 contains an image forming part 2, a retransfer unit 3, and a sheet feeder 4. The image forming part 2 includes five image forming units 5-1, 5-2, 5-3, 5-4, and 5-5 (sometimes inclusively referred to as image forming units 5) arranged in tandem.

Of the five image forming units 5 the upstream (relative to the direction of the travel of paper) three image forming units 5-1, 5-2, and 5-3 (the right-hand side in FIG. 1) each form a monochromatic color toner image of magenta (M), cyan (C), and yellow (Y), respectively, which are three primary colors of subtractive color mixing. The image forming unit 5-4 downstream from the three image forming units 5-1, 5-2, and 5-3 forms a monochromatic image of black (K). The four color images are overprinted on a surface (hereinafter sometimes simply referred to as a pressure-sensitive adhesive layer surface) on which a pressure-sensitive adhesive layer is provided in a hereinafter described release paper, to create a full-color image.

Of the five image forming units 5, the most downstream (the left-hand side in FIG. 1) image forming unit 5-5 forms an image using a hereinafter described label base composition. As used herein, the term “image” refers to any image developed on a photoreceptor drum irrespective of its two-dimensional shape, either solid or graphic.

The image forming units 5-1 through 5-5 have the same structure except for the color or composition of the developer contained in a developing unit. Accordingly, the remainder of the description of the image forming units 5 will be confined to the image forming unit 5-4, it being understood that the other image forming units are virtually identical thereto.

The image forming unit 5 includes a photoreceptor drum 6, a cleaner 7, a charging roller 8, a developing unit 9 having an opening at the bottom thereof, and a developing roller 11 fitted into the opening of the developing unit 9. The cleaner 7, the charging roller 8, the developing unit 9, and the developing roller 11 are disposed along the periphery of the photoreceptor drum 6.

An optical write head 12 is disposed close to the upper periphery of the photoreceptor drum 6 between the charging roller 8 and the developing unit 9. A transfer belt 13 is provided close to the lower periphery of the photoreceptor drum 6. Opposite to the photoreceptor drum 6 with respect to the transfer belt 13 is provided a transfer unit 14 that is pressed against the lower periphery of the photoreceptor drum 6 via the transfer belt 13.

The transfer belt 13 is formed of an electroconductive sheet material made of a resin containing electroconductive carbon or an ion conductive substance. The transfer belt 13 is entrained over a driving roller 15 and a driven roller 16 and driven by the driving roller 15 to run cyclically in a counterclockwise direction indicated by arrows a, b, and c in FIG. 1.

The photoreceptor drum 6 rotates clockwise as viewed in FIG. 1. The peripheral surface of the photoreceptor drum 6 is uniformly electrically charged by the charging roller 8 (initialization). Image information is optically written by the optical write head 12 to form an electrostatic latent image on the surface of the photoreceptor drum 6. The latent image is visualized (developed) into a toner image with a toner supplied from the developing unit 9 to the developing roller 11. As the photoreceptor drum 6 rotates, the toner image on the surface of the photoreceptor drum 6 is moved to the position of transfer position where the photoreceptor drum 6 and the transfer unit 14 face each other.

The sheet feeder 4 includes a paper feed cassette 17, which is loaded with a stack of cut sheets of release paper 18 having a pressure sensitive adhesive layer with the adhesive layer side down. The sheet feeder 4 operates to pick up a single sheet from the paper feed cassette by a paper pickup roller 19 and deliver the sheet to a pair of stand-by rollers 22 through a guide way 21. Otherwise, when a small number of labels are to be produced, a sheet of release paper 18 is fed from a manual paper feed (MPF) tray 24 detachably set on an opened part 23 of the housing of the apparatus by a paper pickup roller 25 and delivered to the stand-by rollers 22.

The pair of stand-by rollers 22 operates to feed the release paper 18 to the transfer belt 13 with such timing that the leading edge of an image area (a region at which a toner image is to he printed) of the adhesive layer of the release paper 18 matches the leading edge of the toner image formed on the photoreceptor drum 6 of the image forming unit 5-5 that is the most downstream in the direction of the travel of the release paper 18.

The release paper 18 is transported while electrostatically adsorbed to the upper side of the cyclically running transfer belt 13 and moves with the transfer belt 13 from upstream to downstream in the direction of its travel right under the photoreceptor drum 6. At this time, the transfer belt 13 is downward away from the image forming units 5-1, 5-2, 5-3, and 5-4. On the other hand, the image forming unit 5-5 operating to print a toner image on the adhesive layer is situated downward from the upper retracted position to bring its photoreceptor drum 6 into contact with the transfer belt 13.

An image of the label base composition (toner) is thus transferred to the adhesive layer side of the release paper 18 at the position of transfer position of the image forming unit 5-5. The image of the label base composition formed on the adhesive layer is a solid image.

The release paper 18 having the solid image of the label base composition transferred to its adhesive layer side is then forwarded to a fixing unit 26. The fixing unit 26 includes a hot roller 26a, a press roller 26b, and a cleaner 26c. The release paper 18 is transferred with being clipped between the hot roller 26a and the press roller 26b, whereby the solid image of label base composition is fused and fixed onto the adhesive layer by the action of heat and pressure. The cleaner 26c removes any residual toner remaining on the hot roller 26a.

The release paper 18 having the solid image of label base composition fixed on its adhesive layer side through the fixing unit 26 is transported to a retransfer unit 3 when a switch-over plate 27 that is pivotable about a pivot point 28 is at its upper position indicated by a solid line in FIG. 1. When, on the other hand, the pivotable switch-over plate 27 is at its lower position indicated by a broken line, the release paper 18 is transported upward by a pair of conveying rollers 29 and ejected onto an output tray 32 by output roller 31.

The retransfer unit 3 has in the inside thereof pairs of transfer rollers 33a, 33b, 33c, 33d, and 33e. The retransfer unit 3 operates to suspend the transport of the printed release paper 18 and return the release paper 18 to the guide way 21 by means of the transfer rollers 33a to 33e to allow for overprinting.

In the present embodiment illustrated in FIG. 1, the switch-over plate 27 is pivoted upward to the position depicted by a solid line so that the release paper 18 having a solid image of a label base toner fixed thereon is sent to the retransfer unit 3 in order to produce a label having not only the label base but a graphic image printed on the label base.

The pair of stand-by rollers 22 feeds the returned release paper 18 onto the transfer belt 13 with such timing that the leading edge of an image area (a region at which a toner image is to be printed) on the adhesive layer side of the release paper 18 matches the leading edge of the toner image formed on the photoreceptor drum 6 of the image forming unit 5-1 that is the most upstream in the direction of the travel of the release paper 18. A toner image of a first color is transferred to the label base on the release paper 18 at the transfer position of the image forming unit 5-1. A toner image of a second color is transferred to the label base of the release paper 18 at the transfer position of the image forming unit 5-2. A toner image of a third color is transferred to the label base of the release paper 18 at the transfer position of the image forming unit 5-3. Finally, a toner image of black color is transferred to the label base of the release paper 18 at the transfer position of the image forming unit 5-4.

During the full-color printing on the label base, the image forming units 5-1 to 5-4 are set in printing mode while the image forming unit 5-5 is located upward from the position where it is in contact with the transfer belt 13.

The release paper 18 having a four-color print image thus transferred to the solid image of the label base composition which has been fixed to the adhesive layer is then introduced into the fixing unit 26, where the four-color toner image is fixed on the solid image of the label base composition through a pass between the hot roller 26a and the press roller 26b and ejected to the downstream side. The release paper 18 ejected from the fixing unit 26 is, when the pivotable switch-over plate 27 is at its lower position indicated by a broken line, transported upward by a pair of conveying rollers 29 and ejected to the output tray 32 by the output roller 31 with its printed side down.

There are thus completed formation of a label base on the adhesive layer side of release paper using the label base composition of the present invention and preparation of a label having a release paper with a full-color image of ordinary toners printed on the label base.

Preparation of release paper with a pressure sensitive adhesive layer (hereinafter referred to as a label liner) will be described briefly. The label liner for use in the present embodiment is prepared by applying a pressure sensitive adhesive (Spray Adhesive 55 from 3M Co.) to release paper, applying an aqueous dispersion of a polyethylene vinyl acetate resin to the pressure sensitive adhesive layer, and drying to remove the water content.

The resins constituting the label base composition, which is transferred and fixed in film form to the adhesive layer of the resulting label liner, will be described. As a result of researches into various resins as a candidate material for making up the label base composition, it has been ascertained that marked improvements are obtained as will be described by using a polyester resin mainly comprising a polycondensation product between succinic acid and 1,4-butanediol, namely polybutylene succinate. The film formed of the label base composition exhibits improved film characteristics. The softening point of the label base composition, which is an important factor in fixing the composition onto the label liner, is on a non-problematic level for practical use. The fixed film of the composition exhibits excellent printability with color toners and the like.

### EXAMPLE

The invention will now be illustrated in greater detail with reference to Synthesis Examples, Preparation Examples, Examples, and Comparative Examples. In Preparation Examples, Examples, and Comparative Examples, various physical properties were determined as follows.

### Softening Point

Flow Tester CFT-500D from Shimadzu Corp, was used under the following conditions: sample weight, 1 g; rate of temperature rise, 6° C./min; load, 20 kg; nozzle diameter, 1 mm; and nozzle length, 1 mm. A ½ method temperature at which one-half of the sample is extruded was taken as a softening point.

### Particle Size

A particle size analyzer FPIA-2100 from Sysmex Corp. was used. A small amount of a sample (label base composition) was put in a beaker and dispersed in purified water containing a surfactant using an ultrasonic cleaner. A volume average particle size D50 was obtained.

### Tensile Breaking Elongation (%)

A label base of film shape was prepared using a label base composition by the method described later. The resulting film was evaluated for tensile strength by determining a tensile breaking elongation (%). The measurement was conducted using a tensile tester AUTOGRAPH AGS-J from Shimadzu Corp. in accordance with JIS K 7113 (testing method for tensile properties of plastics, the 1995 edition) under the following conditions: specimen, 10 mm wide and 250 mm long strip (JIS No. 4 specimen); tensile speed, 10 mm/min; jaw separation, 170 mm; gauge length (GL) 100 mm; and measuring temperature, 23° C. Five specimens per sample (n=5) were tested to obtain an arithmetic average. The elongation (%) was calculated by subtracting the original GL from the GL, at break, dividing the difference by the original GL, and multiplying the quotient by 100.

While in Examples and Comparative Examples measurement of tensile breaking elongation was made in accordance with TN K 7113 (testing method for tensile properties of plastics, the 1995 edition), the test method is not limited thereto. For example, the above described size and number of specimens (n) are only illustrative of the tensile testing procedure. Any other tensile test standards corresponding to JIS K 7113-1995, such as ASTM D638 or ISO 527-1, may be followed.

### Synthesis of Polybutylene Succinate as a Main Component of Label Base Composition

In Synthesis Examples 1 to 9, polyester resins as a main component of the label base composition were synthesized. In Preparation Examples 1 to 22, label base compositions were prepared using these polyester resins. In Examples and Comparative Examples, labels were made using the label base compositions.

### Synthesis Examples 1-1 to 1-4

(Synthesis Example 1-1) To 100 parts (by weight, hereinafter the same) of succinic acid and 89 parts of 1,4-butanediol was added 5 parts of a 88% aqueous solution of lactic acid having dissolved therein 0.4 parts of malic acid and 1 part of germanium dioxide. After purging the reaction system with nitrogen, the mixture was allowed to react at 220° C. for 1 hour. The reaction system was evacuated to 70 Pa over a period of 1.5 hours while elevating the temperature up to 230° C. The polymerization reaction was further continued for an additional 2 hour period to yield Polybutylene Succinate A represented by formula (3):

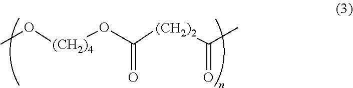

Polybutylene succinate resins B to D were synthesized in the same manner as Synthesis Example 1-1 except for changing the reaction conditions as follows.

(Synthesis Example 1-2) Polybutylene Succinate B was prepared in the same manner as in Synthesis Example 1-1, except for changing the 2-hour polymerization reaction under reduced pressure of 70 Pa to a 4-hour polymerization reaction under reduced pressure of 70 Pa.

(Synthesis Example 1-3) Polybutylene Succinate C was prepared in the same manner as in Synthesis Example 1-1, except for changing the 2-hour polymerization reaction under reduced pressure of 70 Pa to an 8-hour polymerization reaction under reduced pressure of 70 Pa.

(Synthesis Example 1-4) Polybutylene Succinate D was prepared in the same manner as in Synthesis Example 1-1, except for changing the 2-hour polymerization reaction under reduced pressure of 70 Pa to a 16-hour polymerization reaction under reduced pressure of 70 Pa.

### Synthesis Example 2

To 47 parts of succinic acid and 32 parts of ethylene glycol was added 0.03 parts of manganese (11) acetate tetrahydrate, and the mixture was allowed to react at 200° C. for 2 hours in nitrogen stream. Water and excess ethylene glycol were then removed by evaporation under reduced pressure. To the reaction mixture was added 0.14 parts of tetrabutyl titanate, followed by allowing the mixture to react at 200° C. under reduced pressure of 1 to 2 mmHg for 4 hours to yield Polyethylene Succinate represented by formula (4):

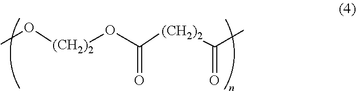

### Synthesis Example 3

Polypropylene Succinate represented by formula (5) below was prepared in the same manner as in Synthesis Example 2, except for using 47 parts of succinic acid and 39 parts of 1,3-propanediol.

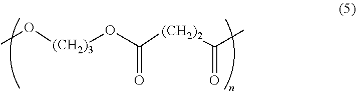

### Synthesis Example 4

Polyhexamethylene Succinate represented by formula (6) below was prepared in the same manner as in Synthesis Example 2, except for using 47 parts of succinic acid and 61 parts of 1,6-hexanediol,

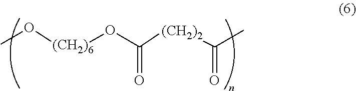

### Synthesis Example 5

Polybutylene Succinate Adipate resin A (molar ratio: succinic acid/adipic acid=85/15) represented by formula (7) below was prepared in the same manner as in Synthesis Example 1-1. except for replacing 100 parts of succinic acid with 85 parts of succinic acid and 19 parts of adipic acid.

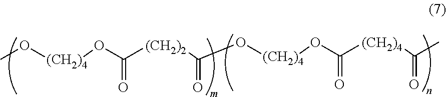

### Synthesis Example 6

Polybutylene Succinate Adipate resin B (molar ratio: succinic acid/adipic acid=70/30) represented by formula (7) above was prepared in the same manner as in Synthesis Example 1-1, except for replacing 100 parts of succinic acid with 70 parts of succinic acid and 37 parts of adipic acid.

### Synthesis Example 7

Polybutylene Succinate Adipate resin C (molar ratio: succinic acid/adipic acid=50/50) represented by formula (7) above was prepared in the same manner as in Synthesis Example 1-1, except for replacing 100 parts of succinic acid with 50 parts of succinic acid and 62 parts of adipic acid.

### Synthesis Example 8

Polybutylene Succinate Sebacate resin (molar ratio: succinic acid/sebacic acid=85/15) represented by formula (8) below was prepared in the same manner as in Synthesis Example 1-1, except for replacing 100 parts of succinic acid with 85 parts of succinic acid and 26 parts of sebacic acid.

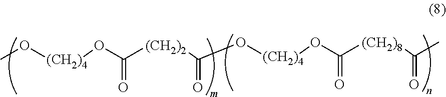

### Synthesis Example 9

Polybutylene Succinate Terephthalate resin (molar ratio: succinic acid/terephthalic acid=85/15) represented by formula (9) below was prepared in the same manner as in Synthesis Example 1-1, except for replacing 100 parts of succinic acid with 85 parts of succinic acid and 21 parts of terephthalic acid.

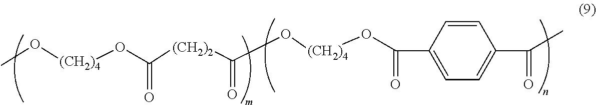

### Preparation of Label Base Composition

### Preparation Example 1

A mixture of 96.5 parts of Polybutylene Succinate A obtained in Synthesis Example 1-1, 1 part of LR-147 from Japan Carlit Co., Ltd. as a charge control agent, and 2.5 parts of carnauba wax from S. Kato & Co. was kneaded in a twin screw extruder. The resulting blend was pulverized to powder having a D50 (on volume basis, hereinafter the same) of 37 μm under liquid nitrogen in a pulverizer RINLEX MILL LX-0 from Hosokawa Micron Corp.

Into 100 parts of the resulting particles were blended 0.4 parts of hydrophobilized silica particles (TG810G from Cabot Corp. and 1.4 parts of RY50 from Nippon Aerosil Co., Ltd. as external additives in a Henschel mixer while stirring to prepare Label Base Composition 1 (D50:37 μm; softening point: 125° C.).

### Preparation Examples 2 to 4

Label Base Compositions 2, 3 and 4 were prepared in the same manner as in Preparation Example 1, except for replacing Polybutylene Succinate A with each of Polybutylene Succinate resins B to D prepared in Synthesis Examples 1-2 to 1-4.

Label Base Composition 2: D50, 39 μm; softening point, 131° C.

Label Base Composition 3: D50, 37 μm; softening point, 121° C.

Label Base Composition 4: D50, 35 μm; softening point, 131° C.

### Preparation Example 5

A white Label Base Composition 5, having a D50 of 33 μm and a softening point of 126° C. was prepared in the same manner as in Preparation Example 1, except for using, as raw materials, 81.5 parts of Polybutylene Succinate B obtained in Synthesis Example 1-2, 15 parts of titanium oxide CR-60 from Ishihara Sangyo Kaisha, Ltd., 1 part of LR-147 from Japan Carlit Co., Ltd., and 2.5 parts of carnauba wax from S. Kato & Co.

### Preparation Examples 6 to 13

Label Base Compositions 6 through 13 were obtained in the same manner as in Preparation Example 1, except for using 96.5 parts of the polyester resins prepared in Synthesis Examples 2 through 9.

Label Base Composition 6: D50, 33 μm; softening point, 118° C.

Label Base Composition 7: D50, 38 μm; softening point, 120° C.

Label Base Composition 8: D50, 40 μm, softening point, 106° C.

Label Base Composition 9: D50, 44 μm; softening point, 105° C.

Label Base Composition 10: D50, 47 μm, softening point, 95° C.

Label Base Composition 11: D50, 52 μm; softening point, 84° C.

Label Base Composition 12: D50, 38 μm; softening point, 95° C.

Label Base Composition 13: D50, 34 μm; softening point, 137° C.

### Preparation Example 14

Label Base Composition 14 was prepared by treating resin particles with external additives in the same manner as in Preparation Example 1, except for using resin particles of a polyvinyl acetal resin S-LEC BL-2 represented by formula (10) shown below, from Sekisui Chemical Co., Ltd. as a raw material. The resulting composition had a D50 of 43 μm and a softening point of 131° C.

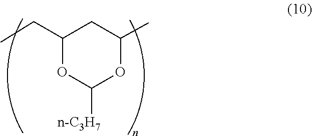

### Preparation Example 15

Into a reactor were added 100 parts of L-lactide from Purac Japan and 0.10 part of stearyl alcohol, followed by stirring at 190° C. in nitrogen atmosphere. To the mixture was added 0.05 parts of tin octylate, followed by further stirring at 190° C. for 2 hours. In order to remove residual L-lactide, the stirring was continued for 1 hour under reduced pressure of 10 mmHg, thereby obtaining polylactic acid (PLA) represented by formula (11) below and having an Mw of 272,000. The resulting PLA was mixed with a polyethylene glycol resin and kneaded in a twin screw extruder. The blend as extruded from the extruder was immersed in water to dissolve the polyethylene glycol in water.

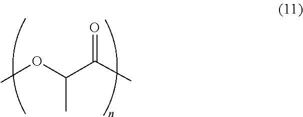

The thus settled PLA particles were collected and re-dispersed in ion exchanged water. The same washing operation was repeated seven times. The washed PLA particles were passed through a sieve with openings of 32 μm to remove coarse particles. The resulting fine particles were dried and treated with external additives in the same manner as in Preparation Example 1 to prepare Label Base Composition 15 (D50, 27 μm; softening point, 158° C.).

### Preparation Example 16

Label Base Composition 16 was prepared by treating resin particles with external additives in the same manner as in Preparation Example 1, except for using a low density polyethylene resin represented by formula (12) shown below, NOVATEC LDLF240 from Japan Polyethylene Corp. as a raw material. The resulting composition had a D50 of 46 μm and a softening point of 131° C.

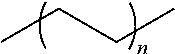

### Preparation Example /7

Label Base Composition 17 was prepared by treating resin particles with external additives in the same manner as in Preparation Example 1, except for using polyethylene particles having formula (12) shown above, FLO-THENE UF-4 from Sumitomo Seika Chemical Co., Ltd., as a raw material. The resulting composition had a D50 of 15 μm and a softening point of 140° C.

### Preparation Example 18

Label Base Composition 18 was prepared by treating resin particles with external additives in the same manner as in Preparation Example 1, except for using a polyethylene terephthalate resin represented by formula (13) shown below, NOVAPEX IG226S from Mitsubishi Chemical Co., Ltd., as a raw material. The resulting composition had a D50 of 76 μm and a softening point of 235° C.

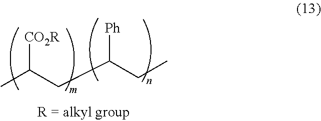

### Preparation Example 19

A mixture of 96.5 parts of polyester resin A for toner from Kao Corp., 1 part of LR-147 from Japan Carlit Co., Ltd. as a charge control agent, and 2.5 parts of carnauba wax from S. Kato & Co. was kneaded in a twin screw extruder. The resulting blend was pulverized to powder in an air jet grinder AFG100 from Hosokawa Micron Corp. The resulting resin particles were treated with external additives in the same manner as in Preparation Example 1 to produce Label Base Composition 19, having a D50 of 38 μm and a softening point of 108° C.

### Preparation Example 20

Label Base Composition 20 was prepared in the same manner as in Preparation Example 19, except for using a polyester resin B for toner from Kao Corp. as a starting resin. The resulting composition had a D50 of 39 μm and a softening point of 126° C.

### Preparation Example 21

Label Base Composition 21 was prepared in the same manner as in Preparation Example 19, except for using styrene-acrylic resin A CPR720 from Mitsui Chemical Inc. as a starting resin. The resulting composition had a D50 of 36 μm and a softening point of 120° C.

### Preparation Example 22

Label Base Composition 22 was prepared in the same manner as in Preparation Example 19, except for using styrene-acrylic resin B CPR120 from Mitsui Chemical Inc. as a starting resin. The resulting composition had a D50 of 37 μm and a softening point of 134° C.

### Preparation of Label

### Example 1

Label Base Composition 1 was electrophotographically developed on a label liner of A4 size. The label liner having Label Base Composition 1 developed thereon was heat-pressed at 200° C. to form a 50 μm-thick label base on the label liner. Then, an image was developed and fixed on the label by a printer N5300 from Casio Computer Co., Ltd.

### Examples 2 to 13

Labels were prepared in the same manner as in Example 1, except for using Label Base Compositions 2 to 13.

### Comparative Examples 1 to 9

Labels were prepared in the same manner as in Example 1, except for using Label Base Compositions 14 to 22.

### Evaluation:

The labels prepared in Examples and Comparative Examples were evaluated for film characteristics of the label base, film forming properties of the label base composition, printability of the label, and overall quality. The results obtained are shown in Table 1. In Table, “tensile breaking elongation (%)” and “softening point (° C.)” are the quantitative results of the tests carried out in accordance with the respective methods described above. The film characteristics represented by, for example, tensile strength (resistance to tear when pulled) and impact strength (resistance to fracture when given impact); the film forming properties represented by, for example, powder characteristics during melt kneading and fixability into film firm; printability (fixability of printed image); and the overall quality were qualitatively evaluated and graded “good”, “medium”, or “poor”.

TABLE 1

| | | | Film Characteristics | | | | | |
|---|---|---|---|---|---|---|---|---|
| | | | Tensile | Tensile | Film Forming Properties | | | |
| | | | Breaking | Strength, | Softening | Powder | | |
| | Label Base | | Elongation | Impact | Point | Characteristics, | | Overall |
| Label | Composition | Resin (monomer molar ratio) | (%) | Strength | (° C.) | Fixability | Printability | Grade |
| Ex. 1 | 1 | polybutylene succinate A (100/100) | 450 | good | 125 | good | good | good |
| Ex. 2 | 2 | polybutylene succinate B (100/100) | 300 | good | 131 | good | good | good |
| Ex. 3 | 3 | polybutylene succinate C (100/100) | 100 | good | 121 | good | good | good |
| Ex. 4 | 4 | polybutylene succinate D (100/100) | 50 | good | 131 | good | good | good |
| Ex. 5 | 5 | polybutylene succinate B (100/100) | 300 | good | 126 | good | good | good |
| Ex. 6 | 6 | polyethylene succinate (100/100) | 100 | good | 118 | good | good | good |
| Ex. 7 | 7 | polypropylene succinate (100/100) | 300 | good | 120 | good | good | good |
| Ex. 8 | 8 | polyhexamethylene succinate (100/100) | 600 | good | 106 | good | good | good |
| Ex. 9 | 9 | polybutylene succinate adipate A (100/85/15) | 800 | good | 105 | good | good | good |
| Ex. 10 | 10 | polybutylene succinate adipate B (100/70/30) | 900 | good | 95 | good | good | medium |
| Ex. 11 | 11 | polybutylene succinate adipate C (100/50/50) | >900 | medium | 84 | good | good | medium |
| Ex. 12 | 12 | polybutylene succinate sebacate (100/85/15) | 900 | good | 95 | good | good | good |
| Ex. 13 | 13 | polybutylene succinate terephthalate | 50 | good | 137 | good | good | good |
| | | (100/85/15) | | | | | | |
| Comp. Ex. 1 | 14 | polyvinyl acetal | <1 | poor | 131 | good | good | poor |
| Comp. Ex. 2 | 15 | polylactic acid | 2 | medium | 158 | poor | good | poor |
| Comp. Ex. 3 | 16 | polyethylene | 550 | good | 131 | good | poor | poor |
| Comp. Ex. 4 | 17 | polyethylene | 700 | good | 140 | good | poor | poor |
| Comp. Ex. 5 | 18 | polyethylene terephthalate | 3 | good | 235 | poor | good | poor |
| Comp. Ex. 6 | 19 | polyester A for toner | <1 | poor | 108 | good | good | poor |
| Comp. Ex. 7 | 20 | polyester B for toner | <1 | poor | 126 | good | good | poor |
| Comp. Ex. 8 | 21 | styrene-acrylic resin A for toner | <1 | poor | 120 | good | good | poor |
| Comp. Ex. 9 | 22 | styrene-acrylic resin B for toner | <1 | poor | 134 | good | good | poor |

As proved from the results shown in Table 1, Label Base Compositions 1 to 5 containing polybutylene succinate as a main component were superior in all the properties tested, i.e., film characteristics, film forming properties, and printability. Similarly satisfactory results were obtained with Label Base Compositions 6 to 8 having a diol component other than 1,4-butanediol and with Label Base Compositions 9, 12, and 13 having adipic acid, sebacic acid, and terephthalic acid, respectively, as a comonomer in a molar ratio of 15 mol %, it is noted that Label Base Compositions 10 and 11 having an adipic acid unit in a molar ratio of 30% and 50%, respectively, tended to have slightly inferior powder characteristics, that is, the resin particles were liable to agglomerate and therefore less than easy to handle as powder. In particular the film formed of Label Base Composition 11 having an adipic acid unit in a molar ratio of 50% was too soft to be handled with ease,

In Comparative Example 1, in contrast, the film of Label Base Composition 14 based on the polyvinyl acetal was inferior in tensile strength and impact strength. In Comparative Example 2, the film of Label Base Composition 15 based on the polylactic acid was slightly inferior in impact strength. Besides, Label Base Composition 15 had a relatively high softening point (158° C.) and needed a large amount of energy to be converted to film. It therefore was difficult with Label Base Composition 15 to make a label at a practical fixing speed.

In Comparative Examples 3 and 4, Label Base Compositions 16 and 17 made of polyethylene exhibited good film characteristics and good film forming properties. Nevertheless, when these compositions were converted to film (label base), and a text or graphic image was printed thereon using a color toner, the color toner showed extremely poor fixability thereon so that the image easily came off the surface of the label base. That is, the polyethylene resin had poor printability and was difficult to use as a label base.

Label Base Composition 18 used in Comparative Example 5 based on polyethylene terephthalate (PET), which is often used as a resinous label base, had an extremely high melting temperature (softening point: 235° C.). Such a high temperature is above the temperature range reachable by a fixing unit of ordinary printers. Therefore, it was difficult to apply PET as a label base resin per se. PET is generally included under “polyester” but is not a succinic ester but a terephthalic ester. So, PET has a softening point as high as 200° C. or higher and has therefore not been employed as a toner resin.

In Comparative Examples 6 and 7 where the polyester resins for toner were used and in Comparative Examples 8 and 9 where the styrene-acrylic resins for toner were used, the resulting label bases of film shape had a serious problem of film characteristics represented by poor bending properties. That is, tensile breaking elongation of these resins used to formulate toners was too small to measure, being less than 1%, indicating that the resins were unacceptable for use in film shape.

It is proved from these results that the label base compositions (toners) of Examples 1 through 13 exhibit good film forming properties to provide a label base of film shape on the pressure-sensitive adhesive layer side of a release paper and that the label base formed of the label base compositions is excellent in film characteristics and printability. Inter alia, those label base compositions having a softening point of 140° C. or lower and a breaking elongation (%) of 50% to 450% are revealed to be particularly preferred.

The label base composition used in Example 5 was white and opaque due to titanium oxide and capable of providing a white label.

The label base of the present invention is capable of application to metals, woods, resins, papers, ceramics, and so on.

While 1,4-butanediol was used to prepare polybutylene succinate, as a main component of the composition for label base, in Preparation Examples, the polyester resin for use in the present invention includes those prepared from other dihydroxy-terminated linear aliphatic diols, such as ethylene glycol, 1,3-propanediol, 1,5-pentanediol, 1,6-hexanediol, 1,7-heptanediol, 1,8-octanediol, 1,9-nonanediol, 1,10-decanediol, and 1,12-dodecanediol. Branched diols are considered effective, too, such as 2-methyl-1,3-propanediol, 2,2-dimethyl-1,3-propanediol, 2,5-hexanediol, 1,2-propanediol, 1,2-butanediol, 1,3-butanediol, 1,2-cyclohexanedimethanol, 1,3-cyclohexanedimethanol, and 1,4-cyclohexanedimethanol. These diols may be used either individually or in combination of two or more thereof.

While in Preparation Examples succinic acid was used as an aliphatic dicarboxylic acid, other aliphatic dicarboxylic acid may be used in place of succinic acid, or a plurality of aliphatic dicarboxylic acids may be used in combination. Examples of useful other aliphatic dicarboxylic acids include oxalic acid, malonic acid, glutaric acid, adipic acid, suberic acid, sebacic acid, cyclohexanedicarboxylic acid, fumaric acid, and maleic acid. It is also possible to use an aromatic dicarboxylic acid in combination with the aliphatic dicarboxylic acid. Examples of useful aromatic dicarboxylic acids include phthalic acid, isophthalic acid, terephthalic acid, and naphthalenedicarboxylic acid.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A composition for label base comprising, as a main component, a polyester resin including a repeating unit formed by condensation of an aliphatic dicarboxylic acid and an aliphatic diol.

2. The composition according to claim 1, wherein the aliphatic dicarboxylic acid is succinic acid.

3. The composition according to claim 2, wherein the polyester resin further has another repeating unit formed by condensation of another dicarboxylic acid than succinic acid and an aliphatic diol.

4. The composition according to claim 3, wherein the molar ratio of said other dicarboxylic acid than succinic acid to the total amount of dicarboxylic acids copolymerized with the aliphatic diol is 50% or less.

5. The composition according to claim 4, wherein the aliphatic diol is 1,4-butanediol.

6. The composition according to claim 5, wherein the composition including a characteristic which a breaking elongation is 50% to 450% in a tensile test.

7. The composition according to claim 6, having a softening point of 140° C. or lower.

8. The composition according to claim 1, wherein the aliphatic dicarboxylic acid is succinic acid, and the aliphatic diol is 1,4-butanediol.

9. The composition according to claim 8, wherein the composition including a characteristic which a breaking elongation is 50% to 450% in a tensile test.

10. The composition according to claim 9, having a softening point of 140° C. or lower.

11. The composition according to claim 1, wherein the composition including a characteristic which a breaking elongation is 50% to 450% in a tensile test.

12. The composition according to claim 11, haying a softening point of 140° C. or lower.

13. The composition according to claim 1, having a softening point of 140° C. or lower.

14. A method for producing label base which contains a release paper and a solid image of a composition for label base fixed on a pressure-sensitive adhesive layer of the release paper into a film shape, comprising:
developing the composition for label base comprising, as a main component, a polyester resin having a repeating unit formed by condensation of an aliphatic dicarboxylic acid and an aliphatic diol to form the solid image having a label shape,
transferring the solid image onto the pressure-sensitive adhesive layer side of the release paper, and
fixing the transferred solid image on the pressure-sensitive adhesive layer of the release paper by heat and pressure application into a film shape.

15. The method according to claim 14, wherein the aliphatic dicarboxylic acid is succinic acid.

16. The method according to claim 14, wherein the aliphatic diol is 1,4-butanediol.

17. The method according to claim 14, wherein the aliphatic dicarboxylic acid is succinic acid, and the aliphatic diol is 1,4-butanediol.

18. A label comprising a label base and a label image provided thereon, wherein
the label base contains a release paper and a solid image of a composition for label base fixed on a pressure-sensitive adhesive layer of the release paper into a film shape,
the label base is formed by developing the composition for label base comprising, as a main component, a polyester resin having a repeating unit formed by condensation of an aliphatic dicarboxylic acid and an aliphatic diol to form the solid image having a label shape, transferring the solid image onto the pressure-sensitive adhesive layer side of the release paper, and fixing the transferred solid image on the pressure-sensitive adhesive layer of the release paper by heat and pressure application into a film shape, and
the label image is formed by transferring a toner image to the label base, and fixing the transferred toner image to the label base by heat and pressure application.

19. The label according to claim 18, wherein the aliphatic dicarboxylic acid is succinic acid.

20. The label according to claim 19, wherein the aliphatic diol is 1,4-butanediol.
